(19) United States
(12) Patent Application Publication
(10) Pub. No.: US 2009/0150450 A1
(43) Pub. Date: Jun. 11, 2009

(54) METHOD OF ATTACHING DOCUMENTS TO ONE OR MORE OBJECTS

(75) Inventor: Chinmay Subhash Pandit, Pune (IN)

Correspondence Address: CANTOR COLBURN LLP - IBM LOTUS, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/953,998

(22) Filed: Dec. 11, 2007

(51) Int. Cl. G06F 17/00; G06F 17/30

(52) U.S. Cl. 707/200; 707/E17.007

(57) ABSTRACT

A method of attaching documents to more than one object includes receiving a selection of at least one object from a user of a computer system, the computer system including a file system, attaching one of a newly created open document or a previously stored open document to the at least one object so as to create an attachment to the object, wherein attaching includes associating the newly created open document or the previously stored open document with the at least one object, and one of; transmitting the at least one object with the attachment to at least one recipient and storing the at least one object with the attachment in the file system. The at least one object includes a currently active object of the computer system, a previously saved object of the computer system, or a previously transmitted electronic mail transmission of the computer system.

IBM® is a registered trademark of International Business Machines Corporation, Armonk, N.Y., U.S.A. Other names used herein may be registered trademarks, trademarks or product names of International Business Machines Corporation or other companies.

### BACKGROUND

1. Technical Field

This invention generally relates to attachment of documents. More particularly, this invention relates to attaching a document to more than one object simultaneously.

2. Description of Background

Generally, users of computer systems use a plurality of programs to organize a plurality of objects (e.g., emails or calendar entries). However, in virtually every computing platform, users must traverse a hierarchical file system in order to attach a document to an object. For example, if a user wishes to attach a first document to a first email, and the first document is located within a five-folder hierarchy, the user must typically open or activate the first email and traverse the five folder hierarchy to locate and attach the first document (e.g., a multi-level hierarchical file system with five level access to the first document). Further, if the user wishes to attach a second document within a three-folder hierarchy to the first email, the user most again traverse the file system hierarchy to locate and attach the second document. Moreover, if the user has a plurality of different emails that the user wishes to attach the first document to, the user must traverse the file system hierarchy for every email to locate and attach the first document to every email of the plurality of emails. Thus, the operations become cumbersome and time consuming for the user.

### SUMMARY

A method of attaching documents to more than one object includes receiving a selection of at least one object from a user of a computer system, the computer system including a file system, attaching one of a newly created open document or a previously stored open document to the at least one object so as to create an attachment to the object, wherein, attaching includes associating the newly created open document or the previously stored open document with the at least one object, and one of: transmitting the at least one object with the attachment to at least one recipient and storing the at least one object with the attachment in the file system. The at least one object includes a currently active object of the computer system, a previously saved object of the computer system, or a previously transmitted, within, a predefined period, electronic mail transmission of the computer system.

Additional features and advantages are realized through the techniques of the exemplary embodiments described herein. Other embodiments and aspects of the invention are described in detail herein and are considered a part of the claimed invention. For a better understanding of the invention with advantages and features, refer to the detailed description and to the drawings.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates an exemplary user interface, according to an exemplary embodiment;

FIG. 2 illustrates an exemplary user interface, according to an exemplary embodiment;

FIG. 3 illustrates a flowchart of a method for attaching documents, according to an exemplary embodiment; and

FIG. 4 illustrates a computer apparatus for attaching documents, according to an exemplary embodiment.

The detailed description explains an exemplary embodiment, together with advantages and features, by way of example with reference to the drawings.

### DETAILED DESCRIPTION

According to an exemplary embodiment, a method is provided which significantly increases the simplicity of attaching documents to one or more objects. This increase in simplicity results in a decrease in the time-consuming nature of document attachment, and may therefore result in increased productivity.

According to an exemplary embodiment, a method of attaching documents to one or more objects includes creating a new document, selecting object(s) for document attachment (i.e. objects that are expected to contain the attachment), and transmitting or storing the object(s). For example, as used herein, an object may refer to any application-specific object such as a calendar entry, journal entry, time log entry, or other similar application specific objects. Additionally, an object may refer to, for example, a cross-platform object such as an email, web-log transmission, text message, instant message, or other similar cross-platform objects. It is noted, however, that example embodiments should not be limited to only these examples, as exhaustive description of every possible computer-implemented object is not the purpose of this disclosure.

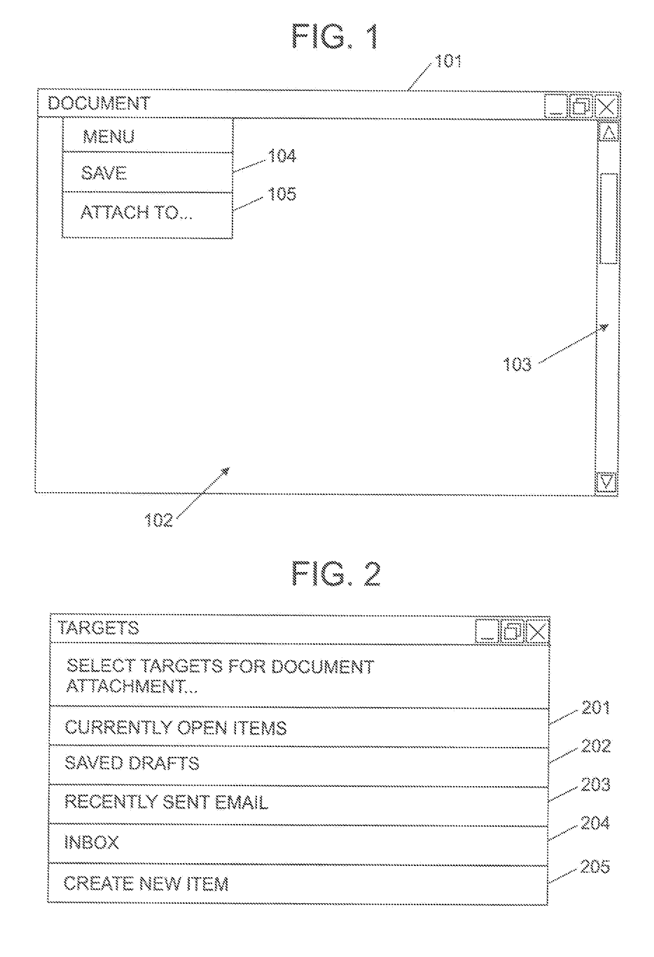

Turning to FIG. 1, an exemplary user interface 101, according to an exemplary embodiment, is illustrated. The user interface 101 includes a document field 102. The document field 102 displays a current document such as, for example, a spreadsheet, text document, data log, etc. Furthermore, the document field 102 may include a document from a separate application interface, such as an additional program used to edit the document, or may be used to edit the document directly. All such iterations are intended to be included within the scope of exemplary embodiments.

User interface 101 further includes scroll bar portion 103. Scroll bar portion 103 provides a user with the ability to scroll through a document which encompasses more than a display apparatus or the user interface 101 will allow for display. For example, if the document is larger than the user interface 101, or if the document is larger than the maximum screen size, a user may use the scroll bar portion to “scroll” through the document for review or editing purposes.

User interface 101 further includes a menu portion including at least a “save” portion 104 and an “attach to . . . ” portion 105. The “save” portion 104 allows a user to store the active document of the document field 102. The “attach to . . . ” portion 105 allows the user to attach the active document of the document held 102 to one or more objects. More clearly, the active document rather than an active object is the subject of the user interaction involved in creating an attachment. In this manner, a user is able to more easily attach a document to one or more objects without traversal of a file system hierarchy multiple times. Hereinafter, targets of attachment (i.e., objects that would contain the attachment) are described more clearly with reference to FIG. 2.

FIG. 2 illustrates an exemplary user interface 201, according to an exemplary embodiment. User interlace 201 includes five selection portions (although exemplary embodiments do not exclude additional selection portions or less selection portions depending upon a particular implementation) providing for different categories of objects for document attachment. For example, an active document may be attached to one or more objects using user interlace 201 through selection of one or more of selection portions 201, 202, 203, 204, and 205.

Selection portion 201 allows for document attachment to one or more currently open items (i.e., objects) of a computer system. For example, a user may have a plurality of calendar items, emails, and journal entries open which correspond to a document. The user may wish to attach the document to at least one of the open items. Through selection of selection portion 201, the user may be provided with a listing or graphical display of all currently open objects such that the user may select particular objects for attaching the document. Upon selection, the document is attached to the selected or objects.

Selection portion 202 allows for document attachment to one or more saved or stored drafts of objects of a computer system. For example, a user may have a plurality of stored drafts of emails which correspond to a document. The user may wish to attach the document to at least one of the stored objects. Through selection of selection portion 202, the user may be provided with a listing or graphical display of all stored objects such that the user may select particular stored drafts for document attachment. Upon selection, the document is attached to the selected draft objects.

Selection portion 203 allows for document attachment to one or more recently transmitted emails of a computer system. For example, a user may have a plurality of emails recently transmitted. The user may wish to transmit a copy of a document to a recipient of a recent email, or alternatively, may have forgotten to attach a document to a previous email. Through selection of portion 203, the user may be provided with a listing or graphical display of recently transmitted emails. For example, the listing or display may be occupied with a predefined or desired number or emails such as, but not limited to, emails transmitted within a predefined period (e.g., within the last bout, within the last twenty-four hours), to particular recipients, to a particular email list, or similar occupation settings. Through selection of one or more previously transmitted emails using exemplary embodiments, the document is attached to the selected emails.

Selection portion 204 allows for document attachment to one or more new emails created based on emails residing in an inbox of an email application of the user's computer system. For example, a user may receive a plurality of requests for a particular document. Through selection of selection portion 204, the user may be provided with a listing or graphical display of emails residing in the inbox of the email application such that the user may select particular emails for document attachment. Upon selection, new items may be created with the document pre-attached for transmittal.

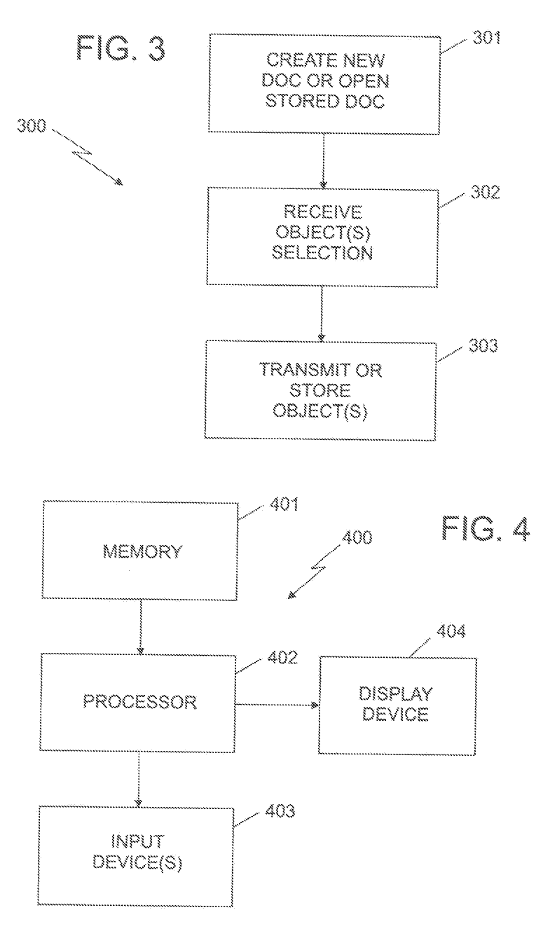

Selection portion 205 allows for document attachment to one or more new objects created by a user. For example, a user may create a new document or open a stored document and wish to attach it to one or more new items. Through selection of selection portion 205, the user may be provided with a listing or graphical display of available object types that may include document attachments. Upon selection of particular object types for attachments, new objects may be created with the document pre-attached for storage, transmittal, etc. Hereinafter, a method of attaching documents is described more fully with reference to FIG. 3.

FIG. 3 illustrates a flowchart of a method 300 for attaching documents, according to an exemplary embodiment. Method 300 includes creating a new document or opening a previously created document at block 301. For example, a user may wish to create a new spreadsheet, text document, etc, and complete or partially complete the document. Alternatively, the user may wish to open a previously stored document, review the document, edit the document; etc. Thus, a computer system, may receive a request to open or create a document and it follows that the computer system will initiate creation or opening of the document. Upon creation or opening, the method 300 includes receiving a selection for object(s) for document attachment at block 302. For example, this may be similar or substantially similar to the examples described above with reference to FIGS. 1-2. The user may use a user interface (e.g., 101 or 201) to select objects for document attachment. Upon selection, the computer system may receive the selection and the document is attached to the selected documents.

More particularly, any object on a computer system may be registered with a computer system service. The service may be accessible by the methodologies of exemplary embodiments. If a user interlace (e.g., 101 or 201) is activated, the service may provide the registered items or objects to the interface. Alternatively, the user interlace (e.g., 101 or 201) may issue a request to retrieve items or objects from the computer system service. Thereafter, the computer system service may respond with the registered items or objects. In this manner, exemplary embodiments gain access to objects registered candidate containers or targets for document attachment.

Upon selection of objects for document attachment, exemplary embodiments may issue requests to the computer system service to register the document as an attachment to the selected documents. As such, traversal of any plurality of file-system hierarchies is circumvented, at least through the user's interaction. If the document is successfully attached to the one or more objects, the computer system, service has registered the object(s) as having the document attached, and the object(s) may be transmitted or stored at block 303.

Alternatively, a universal resource locator (URL) address for the document may be associated with the one or more object's by the exemplary methodologies described herein. For example, upon, creation or opening of the document at block 301, a URL for the document is either loaded or created. The URL may be passed or associated with each selected object for document attachment. Additional methodologies for document attachment are also applicable to exemplary embodiments, and any such methodology allowing for document information to be associated as an attachment to one or more objects in accordance with the method described herein should be considered within the scope of exemplary embodiments.

Furthermore, according to an exemplary embodiment, the method described hereinbefore may be implemented by a computer system or apparatus. For example, FIG. 4 illustrates a computer apparatus for attaching documents, according to an exemplary embodiment. Therefore, portions or the entirety of the method may be executed as instructions in a processor 402 of the computer system 400. The computer system 400 includes memory 401 for storage of instructions and information, input device(s) 403 for computer communication, and display device 404. Thus, the present invention may be implemented, in software, for example, as any suitable computer program on a computer system somewhat similar to computer system 400. For example, a program in accordance with the present invention may be a computer program product causing a computer to execute the example method described herein (e.g., as an application would reside on a processor of a computer apparatus).

The computer program product may include a computer-readable medium having computer program logic or code portions embodied thereon for enabling a processor (e.g., 402) of a computer apparatus (e.g., 400) to perform one or more functions in accordance with one or more of the example methodologies described above. The computer program logic may thus cause the processor to perform one or more of the example methodologies, or one or more functions of a given methodology described herein.

The computer-readable storage medium may be a built-in medium installed inside a computer main body or removable medium arranged so that it can be separated from the computer main body. Examples of the built-in medium include, but are not limited to, rewriteable non-volatile memories, such as RAMs, ROMs, flash memories, and hard disks. Examples of a removable medium may include, but are not limited to, optical storage media such as CD-ROMs and DVDs; magneto-optical storage media such as MOs; magnetism storage media such as floppy disks (trademark), cassette tapes, and removable hard disks; media with a built-in rewriteable non-volatile memory such as memory cards; and media with a built-in ROM, such as ROM cassettes.

Further, such programs, when recorded on computer-readable storage media, may be readily stored and distributed. The storage medium, as it is read, by a computer, may enable the method(s) disclosed herein, in accordance with an exemplary embodiment of the present invention.

While an exemplary embodiment has been described, it will be understood that those skilled in the art, both now and in the future, may make various improvements and enhancements which fall within the scope of the claims which follow. These claims should be construed to maintain the proper protection for the invention first, described.

What is claimed is:

1. A method of attaching documents to more than one object, comprising:
receiving a selection of at least one object from a user of a computer system, the computer system including a file system;
attaching one of a newly created open document or a previously stored open document to the at least one object so as to create an attachment to the object, wherein attaching includes associating the newly created open document or the previously stored open document with the at least one object; and
one of transmitting the at least one object with the attachment to at least one recipient and storing the at least one object with the attachment in the file system; wherein,
the at least one object includes,
a currently active object of the computer system,
a previously saved object of the computer system, or
a previously transmitted, within a predefined period, electronic mail transmission of the computer system.

2. The method of claim 1, wherein the at least one object further includes:
one of an electronic mail transmission residing in an electronic mail application on the computer system; and
a new object being created or edited by the user of the computer system.

3. The method of claim 1, further comprising:
receiving a plurality of selected objects of the computer system; and
attaching one of the newly created open document and the previously stored open document to the plurality of objects simultaneously, wherein attaching includes associating the new document or the previously stored document with the plurality of selected objects.

4. The method of claim 1, wherein the at least one object is one of a calendar entry, a journal entry, a time log entry, an electronic mail transmission, a web-log transmission, a text message, and an instant message.
